(19) United States
(12) Patent Application Publication
(10) Pub. No.: US 2009/0211581 A1
(43) Pub. Date: Aug. 27, 2009

(54) RESPIRATORY MASK WITH MICROPOROUS MEMBRANE AND ACTIVATED CARBON

(76) Inventor: Vishal Bansal, Overland Park, KS (US)

Correspondence Address: PATRICK W. RASCHE (23437);ARMSTRONG TEASDALE LLP, ONE METROPOLITAN SQUARE, SUITE 2600, ST. LOUIS, MO, 63102-2740, US

(21) Appl. No.: 12/037,674

(22) Filed: Feb. 26, 2008

(51) Int. Cl. A62B 7/10; A62B 18/02

(52) U.S. Cl. 128/206.19; 128/206.21; 128/205.29

(57) ABSTRACT

A respiratory mask for protecting a wearer against airborne particulates, chemical vapors, and splashes is disclosed. The mask includes a body sized to fit over at least a portion of the face of a wearer. The body includes a first layer including a microporous membrane having a plurality of interconnecting pores extending therethrough, and a second layer including an absorbent textile. The mask further includes an attachment mechanism for coupling the mask to the face of the wearer.

### BACKGROUND OF THE INVENTION

The field of the invention relates generally to respiratory masks and, more particularly, to a respiratory mask and a filter cartridge that includes a microporous membrane layer and a layer of absorbent textile.

Several types of respiratory masks are known in the art and are commercially available, including, for example, re-usable and disposable masks, respiratory masks for medical use, respiratory masks for professional use where the inhaled air in the working environment requires respiratory protective devices, and respiratory masks for private use, e.g. for the prevention of spreading of infections. Disposable respiratory masks are commonly used for separating the respiratory system of the wearer from the outside environment to prevent the wearer from breathing in viruses, bacteria, or other germs, airborne particulates, volatile organics, aerosols, polluted air, or other contaminants. Thus, such masks make the air cleaner for the wearer, while still allowing oxygen and carbon dioxide to pass through the mask during normal breathing by the wearer. Some masks, such as masks used in the medical fields, also prevent particulate matter, such as bacteria or other germs, emanating from the wearer of the mask from passing through the mask and contaminating other people, such as a patient.

However, at least some known disposable respiratory masks do not provide adequate breathability to the wearer. For instance, moisture vapor present in the breath of the wearer may undesirably accumulate on the mask, making it uncomfortable to the wearer and inhibiting the ability of the mask to adequately filter airborne particulates while allowing the passage of oxygen and carbon dioxide. Such accumulation may increase breathing difficulty when the mask is worn. In a similar manner, oils from the skin of the wearer may accumulate on the mask, also contributing to mask blockage.

Additionally, while several conventional respiratory masks have been designed to restrict the passage of airborne particulates through the mask, at least some such masks may be ineffective at filtering out chemical vapors. As a result, harmful chemical vapors may pass through the mask and be inhaled by the wearer. Additionally, few, if any, conventional disposable respiratory masks have been designed to also effectively prevent passage of fluids through the mask. For example, fluids such as chemicals or various contaminated biological fluids such as blood that are splashed on the outside of the mask can be drawn through the mask to the inside of the mask as a result of capillary action or through suction resulting from the normal respiration of the wearer. As a result, the fluids may undesirably contact the skin and/or respiratory passages of the wearer.

### BRIEF DESCRIPTION OF THE INVENTION

In one aspect, a respiratory mask is provided. The mask includes a body sized to fit over at least a portion of a face of a wearer. The body includes a first layer including a microporous membrane having a plurality of interconnecting pores extending therethrough, and a second layer including an absorbent textile. An attachment mechanism couples the mask to the face of the wearer.

In another aspect, a respiratory mask is provided. The mask includes a body being sized to fit over at least a portion of a face of a wearer. The body includes a first layer including a microporous membrane having a plurality of interconnecting pores extending therethrough, a second layer including an absorbent textile, and a third layer including at least one fabric. An attachment mechanism couples the mask to the face of the wearer.

In another aspect, a filter cartridge is provided. The filter cartridge comprises a filter element. The filter element comprises a first layer and a second layer. The first layer comprises a microporous membrane having a plurality of interconnecting pores extending therethrough, and the second layer comprises an absorbent textile.

### BRIEF DESCRIPTION OF THE DRAWINGS

FIG. 1 is a front elevational view of an exemplary molded, cup-type disposable respiratory mask.

FIG. 2 is a rear elevational view of the mask shown in FIG. 1.

FIG. 3 is a side elevational view, partly in section, of the mask shown in FIG. 1 and taken along line 3-3.

FIG. 4 is a front elevational view of a rectangular-type disposable respiratory mask.

FIG. 5 is a rear elevational view of the mask shown in FIG. 5.

FIG. 6 is an expanded, cross-sectional view of an exemplary respiratory mask body including two layers.

FIGS. 7 and 8 are expanded, cross-sectional views of exemplary respiratory mask bodies including three layers.

### DETAILED DESCRIPTION OF THE INVENTION

The present invention relates generally to respiratory masks. More particularly, the present invention relates to a disposable respiratory mask that includes a first layer including a microporous membrane, such as ePTFE, and a second layer of absorbent textile, such as an activated carbon textile. The mask facilitates protecting the wearer against airborne particulates, bacteria, and other germs, and against chemical vapors and splashes. Filter cartridges for a respiratory mask are also provided.

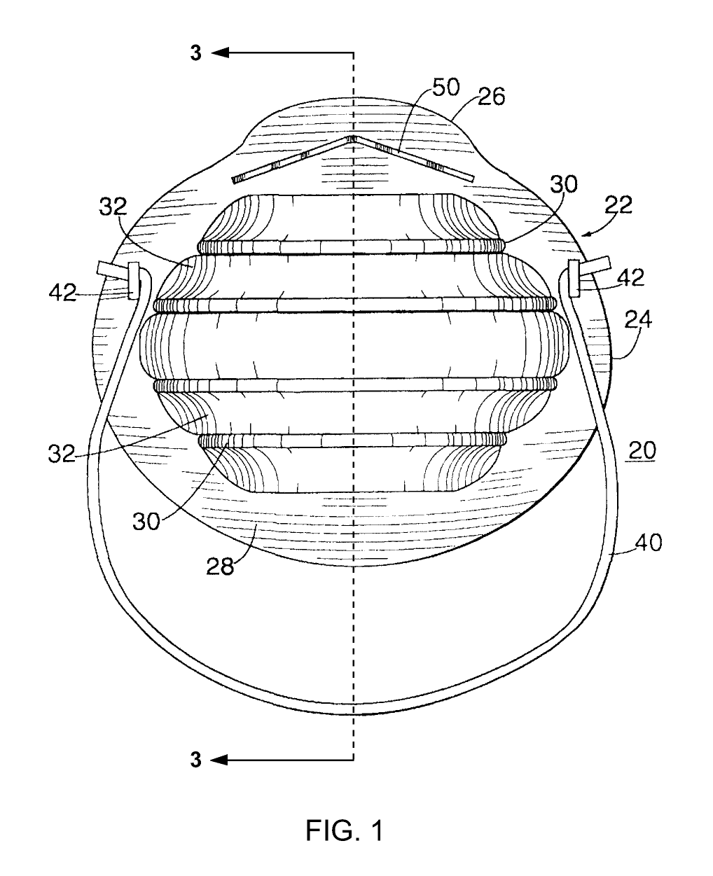

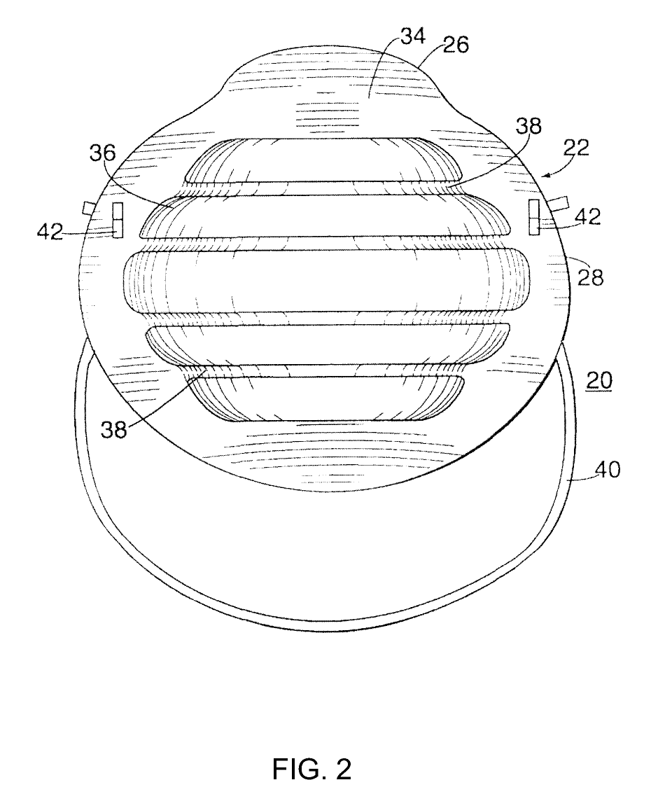

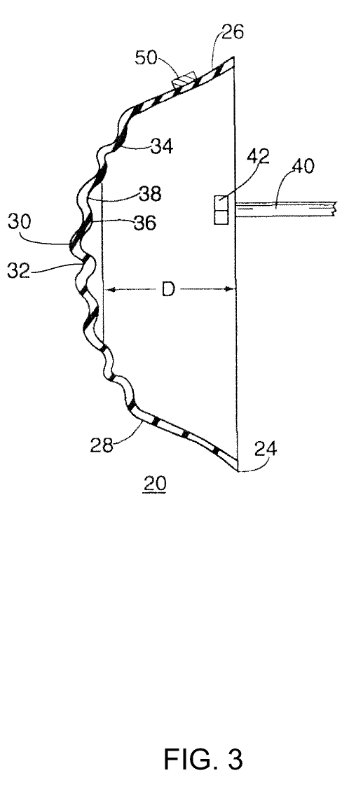

The respiratory mask 20 of the present invention may be of any conventional design. Moreover, the respiratory mask 20 may be disposable or reusable. For example, in one embodiment, the respiratory mask 20 is a disposable respiratory mask, such as those illustrated in the Figures. FIGS. 1-3 show an exemplary cup-type disposable respiratory mask 20. In the exemplary embodiment, a body 22 of mask 20 is formed of two or more layers of materials, as described hereinafter, which may be sealed together around periphery 24 using any suitable sealing mechanism including, but not limited to, heat sealing, adhesives, ultrasonic welding, thermally laminating, and/or laminating using adhesives. Body 22 has a generally cup-shaped configuration with a generally oval-shaped periphery 24. Mask 20 may be sized to overlay most of the wearer's nose, mouth, chin, and parts of the cheeks, or any desired portion thereof. In one embodiment, periphery 24 is “flattened” at 26 to accommodate the wearer's nose. In the exemplary embodiment, front surface 28 of body 22 is formed with a plurality of raised strengthening ribs 30 which extend substantially across a width of body 22. Concave recesses 32 are defined between ribs 30. Rear surface 34 of body 22, in the exemplary embodiment, is a mirror of front surface 28 and includes raised convex ribs 36 that extend between narrow recesses 38. At various points along periphery 24, body 22 is shaped to enable mask 20 to fit snugly in a secure relationship against a wearer's face. A depth D of mask 20 is variously selected to ensure that rear surface 34 does not contact the user's nose.

Mask 20 is held in its desired position on the wearer's face by an attachment mechanism, such as an elastic strip 40 anchored at its ends to body 22 by metal clips 42 or by any suitable attachment mechanism that enables mask 20 to function as described herein. Alternatively, strip 40 can be replaced with any other suitable attachment mechanism, such as but not limited to strings, multiple straps, or any other fastener device that facilitates securing mask 20 to a wearer, as described herein.

A malleable metallic band 50 of aluminum or any other suitable material may optionally be placed adjacent the flattened portion 26 of periphery 24. Once mask 20 is positioned comfortably in a desired orientation on the wearer's face, the wearer can distort the band 50 to conform to the wearer's nose such that a tight seal is formed around the wearer's nose to facilitate preventing inhalation of unfiltered airborne particles.

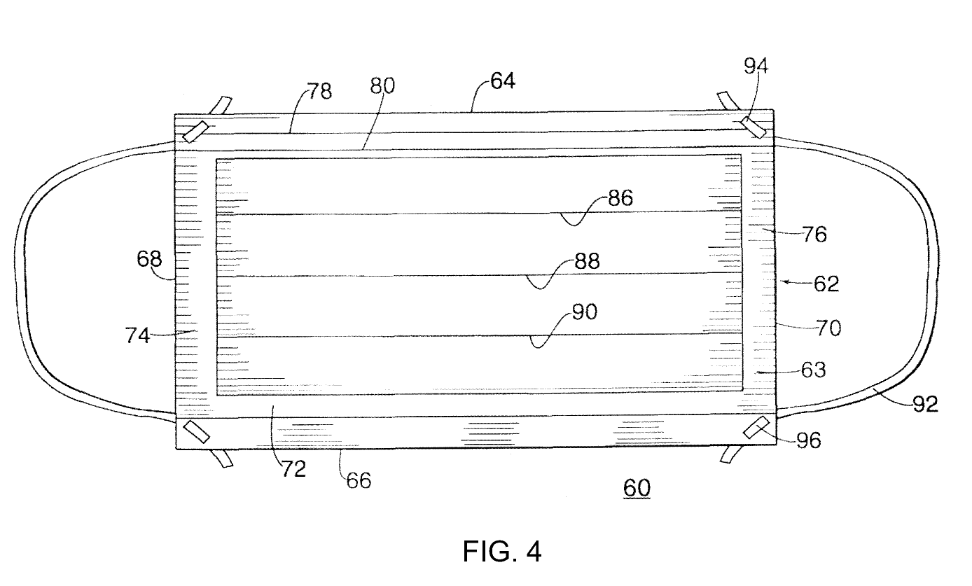

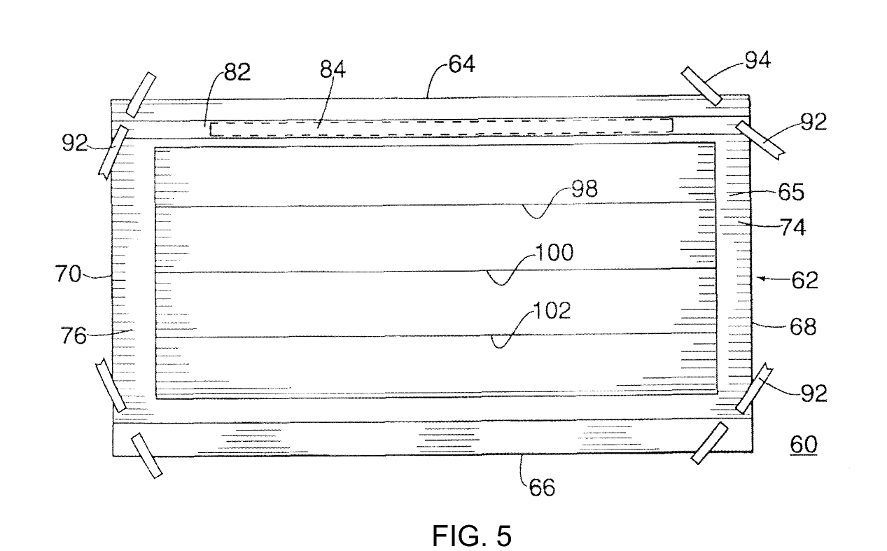

Turning now to FIGS. 4 and 5, an exemplary rectangular-type disposable respiratory mask 60 is shown. Mask 60 includes a body 62 that includes two or more layers, described hereinafter, that are joined together adjacent their top edges 64, bottom edges 66 and side edges 68 and 70. A zone 72 defined adjacent to bottom edge 66 is used to further seal the layers that make up body 62. In one embodiment, the layers are joined along side edges 68 and 70 by using a sealing device (not shown) in zones 74 and 76, respectively. In the exemplary embodiment, top edge 64 is sealed using two spaced-apart, substantially parallel sealing lines 78 and 80 such that a pocket 82 is defined between lines 78 and 80 to receive a malleable metal strip 84 as is shown in phantom in FIG. 4.

In one embodiment, body 62 is fan-folded and includes fold edges 86, 88, and 90 that are visible on front face 63. When mask 60 is subjected to forces from two opposite directions, each force is induced to either top edge 64 or bottom edge 66, and the central portion of mask 60 defined within zones 72, 74, 76, and 80, and mask body 62, expands, enabling mask 60 to extend over and fit the wearer's face from below the bridge of the wearer's nose to under the wearer's chin. A width of body 62 is variously selected to ensure that side edges 68 and 70 cover portions of the cheeks of the wearer. In one embodiment, the sealed edges of body 62 do not expand, but rather act as a pivot for the expansion of body 62 between the sealed edges. A loop 92 is coupled at its ends 94 and 96 to mask body 62 adjacent edge 70, and is sized and oriented to fit over one ear of the wearer. A similar loop 92 is coupled at its ends 94 and 96 to body 62 adjacent edge 68 and is similarly sized and oriented to fit over the wearer's other ear to hold mask 60 in the desired position, relative to and over the wearer's face. Fold edges 98, 100 and 102 are visible on the back face 65 of body 62, as illustrated in FIG. 5. It is to be understood that masks 20 and 60 illustrated in the Figures may contain various modifications and/or additional elements without departing from the scope of the present invention.

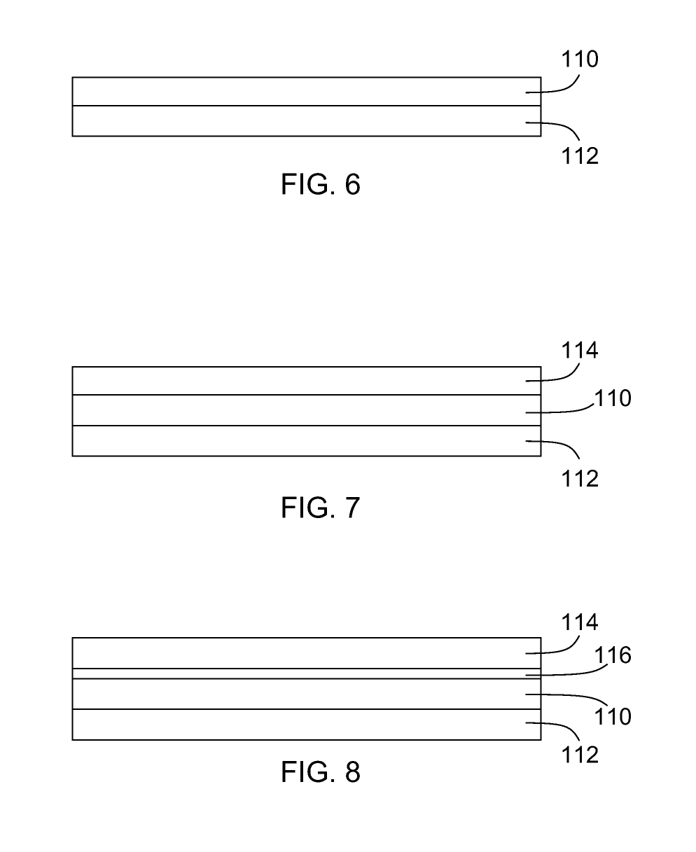

As noted above, each mask body 22 or 62 is formed from at least two layers of material. Referring now to FIGS. 6-8, cross-sectional views of at least a portion of mask body 22 and 62 are shown. In one embodiment, body 22 or 62 includes a first layer 110, which includes a microporous membrane having a plurality of interconnecting pores extending through the membrane, and a second layer 112, which includes an absorbent textile, such as activated carbon textile. The relative positions of first and second layers 110 and 112, respectively, may vary such that in one embodiment first layer 110 may form mask front surface 28 or 63, which faces away from the wearer's face when the mask is worn, or alternately, may form mask rear surface 34 or 65, which faces towards the wearer's face when the mask is worn.

In FIGS. 7 and 8 expanded, cross-sectional views of mask body 22 and 62 including three layers are shown. In the exemplary embodiment, each body 22 or 62 includes a first layer 110, which includes a microporous membrane having a plurality of interconnecting pores extending through the membrane, a second layer 112 including an absorbent textile, and a third layer 114, including at least one fabric material such as a woven or non-woven fabric. In one embodiment, the fabric of third layer 114 is laminated to the microporous membrane of first layer 110 to form a composite laminate.

Third layer 114 and first layer 110 may be laminated together using any means known in the art. For example, the layers can be secured together using thermal bonding. Thermal bonding includes continuous or discontinuous bonding using a heated roll. Point bonding is one suitable example of such a technique. Thermal bonds should also be understood to include various ultrasonic, microwave, and other bonding methods, wherein the heat is generated in the layers.

In alternative embodiments, first layer 110 and third layer 114 are laminated together using a suitable laminating adhesive composition 116, as shown in FIG. 8. Suitable adhesive compositions can include, but are not limited to hot melt adhesives, such as various polyurethane adhesives, amorphous polyalphaolefin adhesives, styrenic block copolymers, and the like, and latex adhesives. Examples of suitable adhesives are commercially available, and include hotmelt polyurethane adhesives such as those sold by FORBO. Typically, the adhesive composition can be applied to the desired area of first layer 110 or third layer 114 by spraying, knifing, roller coating, or any other means suitable in the art for applying adhesive compositions. Typically, the adhesive is applied in a suitable pattern, such as a dot pattern, to avoid completely blocking pores present in first layer 110 and/or third layer 114 and to minimize interference with air flow through the mask. In one embodiment, adhesive composition 116 is applied to the desired area of first layer 110 and/or third layer 114 in an amount of from about 4 grams per square meter to about 20 grams per square meter.

The positioning of first, second, and third layers, 110, 112, and 114, respectively, may vary such that any of first, second, or third layers, 111, 112, or 114, respectively, may form mask front surface 28 or 63 or alternately, may form mask rear surface 34 or 65. Typically, however, the arrangement of layers 110, 112, and 114 will be as shown in FIGS. 7 and 8, with third layer 114 forming mask rear surface 34 or 65, and second layer 112 forming mask front surface 28 or 63. It should be understood that while masks 20 and 60 including only two and three layers of materials are shown in the Figures, masks including more than three layers (e.g., a mask including one or more layers of microporous membrane, one or more layers of absorbent textile, and/or one or more layers of fabric material) are also within the scope of the present disclosure.

As noted above, first layer 110 comprises a microporous membrane. As used herein, the term “microporous membrane” includes membranes having a mean pore size of about 10 μm or less. The microporous membrane is a three-dimensional matrix or lattice type structure that includes numerous nodes interconnected by numerous fibrils which define a matrix of interconnecting pores extending throughout the microporous membrane. The microporous membrane advantageously has good breathability, allowing carbon dioxide, oxygen, and moisture vapor from a wearer's breath to readily pass through the membrane, while preventing the passage of airborne particulates, bacteria, and other germs, which become entrapped in the pores of the membrane. As a result, the wearer is effectively protected from potentially harmful airborne particulates, while still being able to comfortably breathe when wearing the mask. Additionally, the microporous membrane protects the wearer from liquids, such as chemicals, that may be splashed on the mask. For instance, if the surface tension of the liquid is greater than the surface energy of the microporous membrane, the liquid will be prevented from entering the pores of the microporous membrane, and thus kept away from the skin or respiratory passages of the wearer.

Thus, in one embodiment, the microporous membrane has a relatively high moisture vapor transmission rate (“MVTR”) and air permeability. For example, in one embodiment, the microporous membrane 110 has an MVTR, measured by a modified desiccant method, of at least about 20,000 grams per square meter per day (g/m²/day), and more typically at least about 70,000 grams per square meter per day. The microporous membrane has an air permeability of at least 2 cubic feet per minute per square foot at 0.5 inches water, and more typically has an air permeability of from about 2 cubic feet per minute per square foot at 0.5 inches water to about 35 cubic feet per minute per square foot at 0.5 inches water.

The microporous membrane may be made from a variety of suitable materials, such as expanded polytetrafluoroethylene (ePTFE). The microporous membrane is made by extruding a mixture of polytetrafluoroethylene (PTFE) (commercially available from du Pont under the name TEFLON®) fine particle resin and lubricant, such as ISOPAR lubricants (commercially available from Exxon). The extrudate is then calendered and the calendered extrudate is then “expanded” or stretched in machine and transverse directions to form fibrils connecting nodes, made up of raw dispersion particles present in the fine particle resin, in a three dimensional matrix or lattice type of structure. Surfaces of the nodes and fibrils define the plurality of interconnected pores that are in fluid communication with one another and extend through first layer 110 between both sides of the microporous membrane. Typically, the mean pore size of the pores in the membrane is about 10 μm or less, and more typically is in the range of about 0.1 μm to about 5 μm, and in one embodiment is in the range of about 0.1 μm to about 2 μm. As used herein, “expanded” means sufficiently stretched beyond the elastic limit of the material to introduce permanent set or elongation to the fibrils. The microporous membrane may be fully sintered, partially sintered or unsintered. As used herein, the term “sintering” means changing the state of the PTFE material from crystalline to amorphous. Suitable ePTFE membranes are also available commercially, such as those sold under the trade name BHA-TEX® ePTFE membrane (available from BHA Group, Inc.).

Other materials and methods can also be used to form a suitable microporous membrane that has pores extending throughout the membrane. For example, other suitable materials that may be used to form the microporous membrane include polyolefin, polyamide, polyester, polysulfone, polyether, acrylic and methacrylic polymers, polystyrene, polyurethane, polypropylene, polyethylene, cellulosic polymer, and combinations thereof. Typically, first layer 110 has a thickness of from about 0.01 millimeters to about 2 millimeters, and more typically of from about 0.05 millimeters to about 1 millimeter.

As noted above, second layer 112 includes an absorbent textile, such as an activated carbon textile. In one embodiment, the absorbent textile used in the masks described herein absorbs chemical vapors, thus preventing the vapors from being inhaled by the mask wearer. Additionally, like the microporous membrane, the absorbent textile layer protects the wearer from liquids, such as chemicals, that may be splashed on the mask. In particular, the absorbent textile absorbs the chemicals, including, for instance, chemicals that have passed through the microporous membrane, before the chemicals can penetrate through the mask and contact the skin or respiratory passages of the wearer.

In one embodiment, the absorbent textile is an activated carbon textile. As will be understood by those skilled in the art, activated carbon is a carbon-based material having a high surface area. Activated carbon may come in a variety of forms, such as powdered activated carbon, granulated activated carbon, pelleted activated carbon, fibrous (i.e., textile) activated carbon, and the like, and may be used to absorb volatile organic compounds in gas or liquid form. As used herein, the term “activated carbon textile” is intended to include activated carbon in fiber form, i.e., carbon in fiber form which has been intentionally treated by some process to increase its surface area and therefore its ability to absorb chemical materials which come into contact with the activated carbon textile. In a particular embodiment, the surface area of the activated carbon is at least about 800 square meters per gram (m²/g), with even higher surface areas, e.g., from about 1000 m²/g to about 3000 m²/g, in further embodiments. The form of the activated carbon textile that can be used in the masks of the present disclosure includes layers of woven carbon cloth, knitted carbon cloth, carbon felt, resin bonded carbon batting, carbon cloth, and the like. In one embodiment, second layer 112 includes activated carbon cloth or activated carbon felt. Activated carbon textiles are available commercially, such as those sold under the name C-TEX (available from MAST Carbon), e.g., C-TEX 13, C-TEX 20, C-TEX 27, C-TEX 27, C-TEX 62, and C-TEX 71. In one embodiment, the activated carbon is C-TEX 20, which is a knitted activated carbon material having a surface area of greater than 1200 m²/g.

In addition to activated carbon in fiber form, as described above, the term “activated carbon textile” is also intended to include textiles having activated carbon impregnated therein (i.e., dispersed throughout the textile). Examples of suitable textiles include, but are not limited to, woven materials, non-woven materials, knitted materials, cloths, batting, felt, foams, sponges, membranes, and the like. The textile may have impregnated therein activated carbon in any suitable form including, for example, powdered activated carbon, granulated activated carbon, pelleted activated carbon, fibrous (i.e., textile) activated carbon, and the like. In this embodiment, the textile includes at least about 15 g/m², and more preferably from about 30 g/m² to about 125 g/m² activated carbon.

The absorbent textile that makes up second layer 112 can include as an alternative to or in addition to the activated carbon textile, other absorptive fabrics or compounds, including for example, inorganic particulates such as metal oxides, clay, and the like. Optionally, second layer 112 may also include additional materials, such as thermoplastic adhesives and/or binders, which function to hold the absorbent textile layer together. Second layer 112 typically has a basis weight of from about 30 g/m² to about 300 g/m², and more preferably from about 100 g/m² to about 300 g/m².

As noted above, mask 20 or 60 may optionally include at least a third layer 114, including at least one fabric material. As used herein, the term “fabric material” is intended to include woven materials and knitted materials as well as non-woven materials, which are fibrous webs or materials formed without the aid of a textile weaving or knitting process. Suitable materials from which the fabric material may be formed include, without limitation, synthetic fibers (for example, polyester or polypropylene fibers), natural fibers (for example, wood or cotton fibers), and combinations of natural and synthetic fibers. Typically, third layer 114 will have a basis weight of from about 15 grams per square meter to about 150 grams per square meter, and in one embodiment from about 15 grams per square meter to about 70 grams per square meter.

In some instances, third layer 114 and/or first layer 110 may become contaminated with certain contaminating agents, such as body oils, perspiration, and the like, when contacted with the skin of the wearer. In particular, such contaminants may be absorbed into the fabric material and/or microporous membrane, substantially blocking the pores of the microporous membrane and/or fabric material, and reducing the air permeability and MVTR of the mask. Thus, in certain embodiments, first layer 110 and/or third layer 114 may include an oleophobic treatment. As used herein, the term “oleophobic treatment” means that first layer 110 and/or third layer 114 have been treated with an oleophobic compound, such as various flurochemical polymers, to enhance the oleophobic and hydrophobic properties of these layers. The oleophobic treatment renders the microporous membrane and/or fabric material substantially resistant to contamination by absorbing oils, perspiration, and the like, without adversely affecting the air permeability or MVTR of the mask.

First layer 110 and/or third layer 114 may be oleophobically treated using any suitable means known in the art. For example, a stabilized and diluted dispersion of oleophobic fluoropolymer solids is applied to first layer 110 and/or third layer 114. Stabilizing and wetting agent materials present in the dispersion are removed, allowing the oleophobic fluoropolymer solids to adhere to the surfaces of the nodes and fibrils, which define the pores of the microporous membrane. The oleophobic fluropolymers are heated, allowing them to flow into the pores and coalesce to form a relatively thin, even coating over the nodes and fibrils that define the pores in the microporous membrane. Any suitable oleophobic fluropolymers may be used including, but not limited to, Zonyl® fluoropolymers (commercially available from Dupont).

In one embodiment, masks 20 or 60 typically have an air permeability of from about 8 cubic feet per minute per square foot at 0.5 inches water to about 25 cubic feet per minute per square foot at 0.5 inches water, and more typically of from about 12 cubic feet per minute per square foot at 0.5 inches water to about 25 cubic feet per minute per square foot at 0.5 inches water.

The MVTR of the mask will typically be from about 5,000 grams per square meter per day to about 20,000 grams per square meter per day, and preferably is from about 5,000 grams per square meter per day to about 10,000 grams per square meter per day.

In another embodiment, instead of forming body 22 or 62 of mask 20 or 60, respectively, first, second, and/or third layers, 110, 112, and 114, respectively, can be included in a filter cartridge, such as a replaceable filter cartridge, for use in a respiratory mask. As used herein, the term “filter cartridge” means a structure that includes a filter element and that is adapted for connection to a mask body of a respiratory mask. The filter element can be connected to the mask body using, for example, a housing that surrounds the edges of the filter element. Examples of filter cartridges, such as replaceable filter cartridges, for use in connection with a respiratory mask, are known in the art.

In one embodiment, the filter element of the filter cartridge may include first layer 110, second layer 112, and optionally third layer 114. The positioning of first, second, and third layers, 110, 112, and 114, respectively, in the filter element may vary such that any of first, second, or third layers, 111, 112, or 114, respectively, may form the front (outer) surface of the filter element.

Test Methods

Moisture Vapor Transmission Rate (MVTR): MVTR is tyically measured by a known method termed the Dry Modified Desiccant Method (MDM). This method provides a high relative humidity in contact with the sample without direct liquid contact with the sample membrane.

In the MDM method, an expanded PTFE control membrane is tightly mounted in an embroidery hoop and floated upon the surface of a controlled temperature circulating water bath. A desired amount of a desiccant is placed into a cup. Another expanded PTFE control membrane is sealed to the cup to create a tight and leak-proof microporous barrier containing the desiccant. The test apparatus is located in an environmentally controlled room and the water is maintained at a predetermined temperature.

A membrane sample to be tested is mounted tight in another embroidery hoop and placed in the center of the control membrane in the first hoop. After allowing the control membrane in the first hoop to equilibrate with the water for a predetermined time, the cup assembly is weighed to the nearest [fraction ( 1/1,000)] gram and placed in an inverted manner on the center of the sample membrane in the second hoop.

Water transport is provided by the driving force between the water and the desiccant providing water vapor movement in a direction from the water bath to the desiccant. The sample membrane is tested for a measured time and then the cup assembly is removed and weighed again to within [fraction ( 1/1,000)] gram. The MVTR of the sample is calculated from the weight gain of the cup assembly and is expressed in grams of water per square meter of sample surface area per 24 hours.

Air permeability: Air permeability is measured by a Frazier Air Permeability Tester per ASTM D737 or on a Textest FX 3300 Air Permeability Tester.

In each embodiment, the above-described masks facilitate protecting a wearer against airborne particulates, bacteria and other germs, and chemical vapors and splashes. More specifically, the above-described masks include at least one layer of microporous membrane that facilitates protection of the wearer against airborne particulates, bacteria, and other germs, as well as at least one layer of activated carbon textile that facilitates protection of the wearer against chemical vapors and splashes. Accordingly, the above-described masks facilitate protecting the mask wearer from inhaling various particulates and vapors, while concurrently facilitating good breathability when the mask is worn.

Exemplary embodiments of respiratory masks are described above in detail. These respiratory masks are not limited to the specific embodiments described herein, but rather, components of the masks may be utilized independently and separately from other components described herein. For instance, the respiratory masks and filter cartridges described above may have other industrial or consumer application, and are not limited to use only in those applications as described herein. Rather, the present invention may be implemented and utilized in connection with many other products and in other environments.

While the disclosure has been described in terms of various specific embodiments, those skilled in the art will recognize that the disclosure can be practiced with modification within the spirit and scope of the claims.

What is claimed is:

1. A respiratory mask comprising:
a body being sized to fit over at least a portion of the face of a wearer, said body comprising a first layer comprising a microporous membrane having a plurality of interconnecting pores extending therethrough, and a second layer comprising an absorbent textile; and
an attachment mechanism for coupling said mask to the face of the wearer.

2. A respiratory mask in accordance with claim 1, wherein said microporous membrane comprises a material selected from the group consisting of polyolefin, polyamide, polyester, polysulfone, polyether, acrylic and methacrylic polymers, polystyrene, polyurethane, polypropylene, polyethylene, cellulosic polymer, and combinations thereof.

3. A respiratory mask in accordance with claim 1, wherein said microporous membrane comprises expanded polytetrafluoroethylene.

4. A respiratory mask in accordance with claim 1, wherein said microporous membrane has a mean pore size of from about 0.1 μm to about 5.0 μm.

5. A respiratory mask in accordance with claim 1, wherein said microporous membrane has an air permeability of from about 2 cubic feet per minute per square foot at 0.5 inches of water to about 35 cubic feet per minute per square foot at 0.5 inches of water.

6. A respiratory mask in accordance with claim 1, wherein said microporous membrane comprises an oleophobic treatment.

7. A respiratory mask in accordance with claim 6, wherein said oleophobic treatment comprises flurochemical polymers.

8. A respiratory mask in accordance with claim 1 wherein the absorbent textile comprises an activated carbon textile.

9. A respiratory mask in accordance with claim 8, wherein said activated carbon textile comprises activated carbon fibers.

10. A respiratory mask in accordance with claim 8, wherein said activated carbon textile comprises a textile impregnated with activated carbon.

11. A respiratory mask in accordance with claim 8, wherein said activated carbon textile has a surface area of at least about 800 square meters per gram.

12. A respiratory mask in accordance with claim 1, wherein said mask has an air permeability of from about 8 cubic feet per minute per square foot at 0.5 inches water to about 25 cubic feet per minute per square foot at 0.5 inches water.

13. A respiratory mask in accordance with claim 1, wherein said mask has a moisture vapor transmission rate of from about 5,000 grams per square meter per day to about 20,000 grams per square meter per day.

14. A respiratory mask comprising:
a body being sized to fit over at least a portion of the face of a wearer, said body comprising a first layer comprising a microporous membrane having a plurality of interconnecting pores extending therethrough, a second layer comprising an absorbent textile, and a third layer comprising at least one fabric material; and
an attachment mechanism for coupling said mask to the face of the wearer.

15. A respiratory mask in accordance with claim 14, wherein said fabric material is laminated to said microporous membrane.

16. A respiratory mask in accordance with claim 15, wherein said fabric material is laminated to said microporous membrane using an adhesive composition, thermal bonding, or combinations thereof.

17. A respiratory mask in accordance with claim 14 wherein said microporous membrane comprises expanded polytetrafluoroethylene and said absorbent textile comprises an activated carbon textile.

18. A respiratory mask in accordance with claim 14, wherein at least one of said fabric material and said microporous membrane comprise an oleophobic treatment.

19. A filter cartridge comprising a filter element comprising a first layer and a second layer, the first layer comprising a microporous membrane having a plurality of interconnecting pores extending therethrough, and the second layer comprising an absorbent textile.

20. A filter cartridge in accordance with claim 19, wherein said microporous membrane comprises expanded polytetrafluoroethylene and said absorbent textile comprises an activated carbon textile.
